(19) United States
(12) Patent Application Publication
(10) Pub. No.: US 2002/0090952 A1
(43) Pub. Date: Jul. 11, 2002

(54) Location of devices using wireless network nodes

(76) Inventor: Charles E. Cantwell, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/757,360

(22) Filed: Jan. 8, 2001

(51) Int. Cl. H04Q 7/20

(52) U.S. Cl. 455/456; 342/451; 342/357.01

(57) ABSTRACT

An object device wirelessly communicating with at least one node is located. The nodes wirelessly communicating with the object device are discovered. The nodes are discovered either by querying nodes to discover whether the object device is wirelessly communicating with the nodes or querying nodes to discover devices wirelessly communicating with each node, generating an index of devices wirelessly communicating with each node and the nodes to which each device is wirelessly communicating, selecting the object device from the index, and reading the index to discover the nodes wirelessly communicating with the object device. For each node wirelessly communicating with the object device, a location of a coverage area for the node is discovered. The location of the coverage area for each node is discovered by either reading the location of the coverage area for each node or reading a node location and calculating the location of the coverage area from the node location. From the location of the coverage area for each node wirelessly communicating with the object device, an area of location for the object device is discovered. The area of location for the object device is discovered either by discovering a region common to the coverage areas for each node communicating wirelessly with the object device, discovering a region excluding the coverage areas for each node not communicating wirelessly with the object device, or both.

### FIELD OF THE INVENTION

This invention relates in general to locating devices and, more particularly, to locating devices that are using wireless network nodes.

### BACKGROUND OF THE INVENTION

As wireless networking technology has matured, mobile wireless networked devices have become more prevalent. It is often desirable to determine a location of these mobile wireless networked devices. If the user of the device is in the same location as the device, providing the location of device also provides the location of the user. Knowing the location of the user allows people to find the user as well as allowing the user to find other devices, which are nearby. For example, a user of the mobile device may desire to know where the nearest printer is located.

Prior solutions for locating mobile wireless network devices have required hardware dedicated to locating the devices or unusual networking schemes. It is desirable to utilize existing hardware and networking schemes to provide a location of a mobile wireless networked device.

### SUMMARY OF THE INVENTION

According to principles of the present invention, an object device wirelessly communicating with at least one node is located. The nodes wirelessly communicating with the object device are discovered. For each node wirelessly communicating with the object device, a location of a coverage area for the node is discovered. From the location of the coverage area for each node wirelessly communicating with the object device, an area of location for the object device is discovered.

According to further principles of the present invention, the nodes are discovered either by querying nodes to discover whether the object device is wirelessly communicating with the nodes or querying nodes to discover devices wirelessly communicating with each node, generating an index of devices wirelessly communicating with each node and the nodes to which each device is wirelessly communicating, selecting the object device from the index, and reading the index to discover the nodes wirelessly communicating with the object device.

According to further principles of the present invention, the location of the coverage area for each node is discovered by either reading the location of the coverage area for each node or reading a node location and calculating the location of the coverage area from the node location.

According to further principles of the present invention, the area of location for the object device is discovered either by discovering a region common to the coverage areas for each node communicating wirelessly with the object device, discovering a region excluding the coverage areas for each node not communicating wirelessly with the object device, or both.

### DESCRIPTION OF THE DRAWINGS

FIG. 1 is an illustration of network nodes operating with the present invention.

FIG. 2 is a block diagram representing one embodiment of the system of the present invention for locating a wireless device communicating with a network node.

FIG. 3 is a flow chart illustrating one embodiment of the method of the present invention for locating a wireless device communicating with a network node.

### DETAILED DESCRIPTION OF THE INVENTION

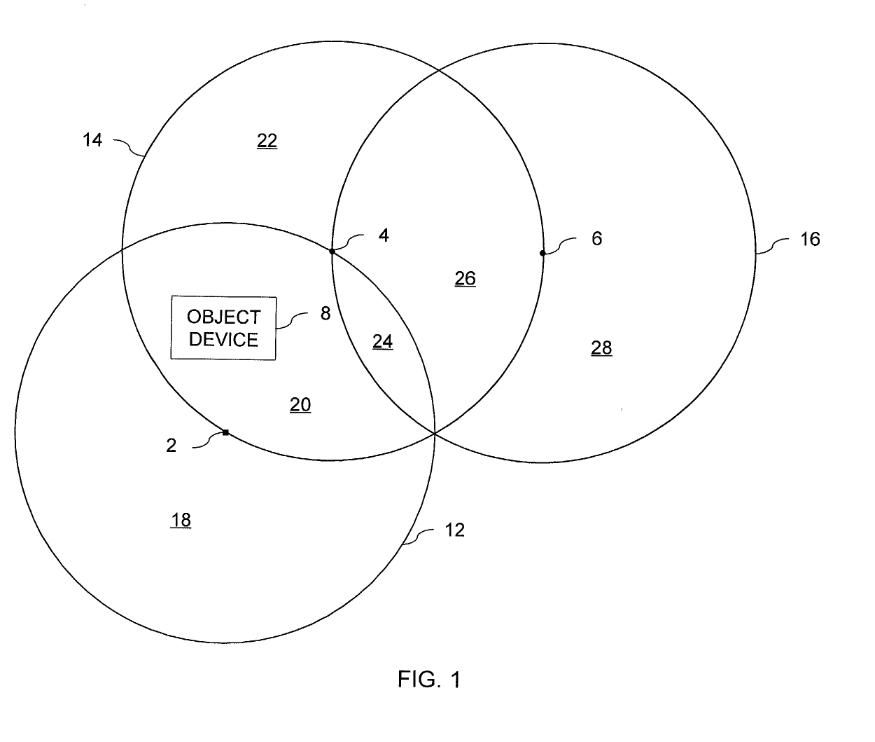

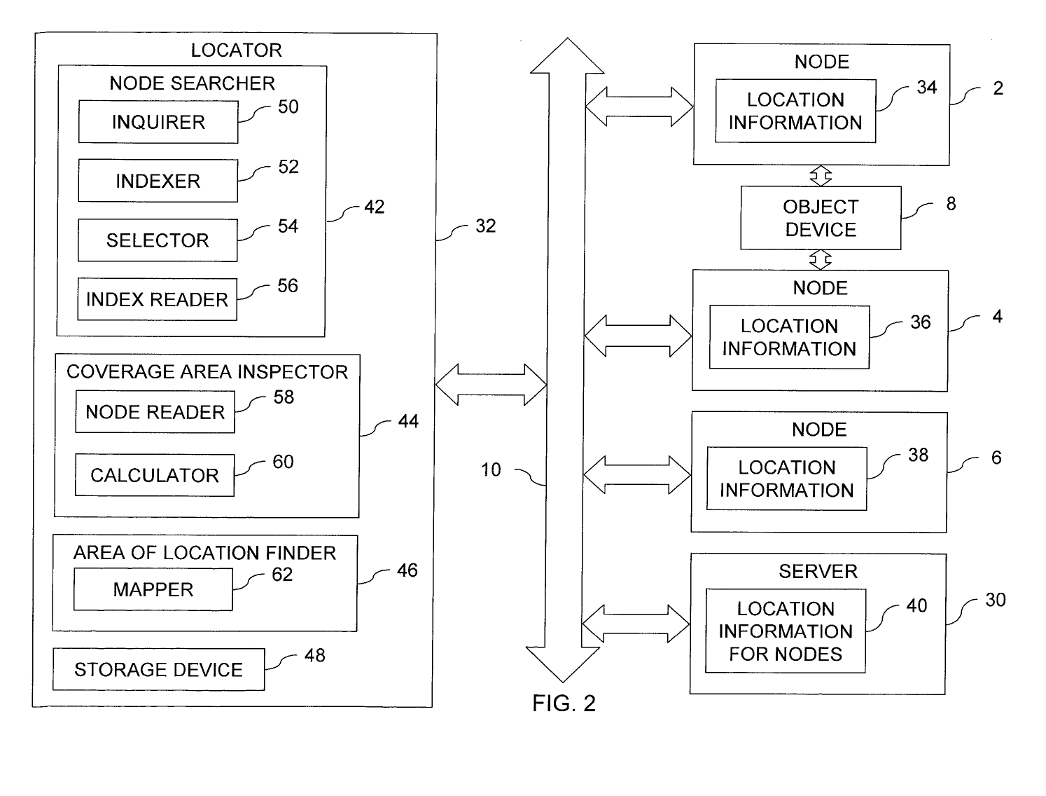

Illustrated in FIG. 1 are wireless communication nodes 2, 4, 6 and an object device 8. Wireless communication nodes 2, 4, 6 are any nodes for providing wireless communication between object device 8 and a network 10 (in FIG. 2). For example, wireless communication nodes 2, 4, 6 are radio frequency (RF) communication nodes for communicating with object device 8 using an RF signal. The pattern of nodes 2, 4, 6 represented in FIG. 1 are intended only to illustrate the operation of the present invention. Any number of nodes may be used with the present invention and the nodes may be configured in any pattern.

Object device 8 is the device sought by the present invention. Object device 8 is any device able to wirelessly communicate with wireless communication nodes 2, 4, 6. Since object device 8 communicates wirelessly with nodes 2, 4, 6, it may be mobile; however, it is not necessary to the present invention that object device 8 be mobile. Examples of object device 8 include a computer, such as a laptop computer, a palmtop computer and a handheld computer; a peripheral device; and a telecommunication device, such as a telephone.

Each node 2, 4, 6, has a coverage area represented by circles 12, 14, 16 surrounding each node 2, 4, 6. Each coverage area 12, 14, 16 is finite and definable. For RF nodes, typical coverage areas include a circle having a radius of 500 feet about the node.

Object device 8 communicates with nodes 2, 4, 6 when within the respective coverage area 12, 14, 16. For example, when object device 8 is within coverage area 12, object device 8 wirelessly communicates with node 2. When object device 8 is also within coverage are 14, object device 8 also wirelessly communicates with node 4.

The pattern of overlapping coverage areas 12, 14, 16 illustrated in FIG. 1 effectively creates several zones 18, 20, 22, 24, 26, 28 into which object device 8 may be located. The zones illustrated in FIG. 1 are intended only to illustrate the present invention. The pattern of nodes actually used will define the zones.

FIG. 2 shows, in block diagram form, a system including wireless communication nodes 2, 4, 6; object device 8; network 10; server 30; and locator 32. Nodes 2, 4, 6 and object device 8 are described above.

Additionally, nodes 2, 4, 6 may include location information 34, 36, 38 accessible by locator 32. Location information 34, 36, 38 is any information indicating the location of nodes 2, 4, 6. Location information 34, 36, 38 may take any form. For example, location information 34, 36, 38 may be included in a tag, name or description.

Network 10 is any network of two or more devices able to communicate with each other. Examples of network 10 include an intranet, a local area network, a wide area network and the Internet. Server 30 is any combination of hardware and software acting as a store for location information 40 for nodes 2, 4, 6 where location information 40 is accessible by locator 32. Location information 40 for nodes 2, 4, 6 is any information indicating the location of nodes 2, 4, 6. Location information 40 for nodes 2, 4, 6 may take any form. For example, location information 40 for nodes 2, 4, 6 may be included in a name or a description.

Locator 32 is any combination of hardware and software able to communicate as necessary to receive information useful for locating object device 8 and process the information to yield an area of location for object device 8. Locator 32 may be embodied separately from object device 8 or within object device 8.

Locator 32 includes node searcher 42, coverage area inspector 44, area of location finder 46 and, optionally, storage device 48. Storage device 48 is any device for storing data or executable code. Storage device 48 may also be a program storage device tangibly embodying a program, applet or instructions executable by locator 32 for performing the method steps of the present invention executable by locator 32. Storage device 48 may be any type of storage media such as magnetic, optical or electronic storage media. Although depicted as integral to locator 32, storage device 48 is alternatively embodied separate from locator 32 and accessible by locator 32.

Node searcher 42 is any combination of hardware and software configured to discover nodes 2, 4, 6 wirelessly communicating with object device 8. In one embodiment, node searcher includes inquirer 50 configured to query nodes 2, 4, 6 to discover whether object device 8 is wirelessly communicating with the nodes 2, 4, 6.

In an alternative embodiment, node searcher 42 includes inquirer 50, indexer 52, selector 54, and index reader 56. Inquirer 50 is any combination of hardware and software configured to query nodes 2, 4, 6 to discover devices wirelessly communicating with each node 2, 4, 6. Indexer 52 is any combination of hardware and software configured to generate an index of devices wirelessly communicating with each node 2, 4, 6 and the nodes 2, 4, 6, to which each device is wirelessly communicating. Selector 54 is any combination of hardware and software configured to select object device 8 from the index created by indexer 52. Index reader 56 is any combination of hardware and software configured to read the index to discover the nodes 2, 4, 6 wirelessly communicating with object device 8.

Coverage area inspector 44 is any combination of hardware and software configured to discover a location of a coverage area 12, 14, 16 for the node 2, 4, 6 for each node 2, 4, 6 wirelessly communicating with object device 8. In one embodiment, coverage area inspector 44 includes node reader 58 configured to read the location of the coverage area 12, 14, 16 for each node 2, 4, 6 wirelessly communicating with object device 8. Node reader 58 reads the location of the coverage areas 12, 14, 16 either from location information 34, 36, 38 or location information 40 for nodes 2, 4, 6, depending on where the information is stored.

In an alternative embodiment, coverage area inspector 44 includes node reader 58 configured to read a node location for each node 2, 4, 6 wirelessly communicating with object device 8 and calculator 60 configured to calculate the location of the coverage area 12, 14, 16 from the node location. Node reader 58 reads the location of nodes 2, 4, 6, either from location information 34, 36, 38 or location information 40 for nodes 2, 4, 6, depending on where the information is stored.

Area of location finder 46 is any combination of hardware and software configured to discover an area of location for object device 8 from the location of the coverage area 12, 14, 16 for each node 2, 4, 6 wirelessly communicating with object device 8. In one embodiment, area of location finder 46 includes a mapper 62 configured to discover a region common to the coverage areas 12, 14, 16 for each node 2, 4, 6 communicating wirelessly with object device 8. In another embodiment, mapper 62 is configured to discover a region excluding the coverage areas 12, 14, 16 for each node 2, 4, 6 not communicating wirelessly with object device 8. Mapper 62 may also be configured to both discover a region common to the coverage areas 12, 14, 16 for each node 2, 4, 6 communicating wirelessly with object device 8 and exclude the coverage areas 12, 14, 16 for each node 2, 4, 6 not communicating wirelessly with object device 8.

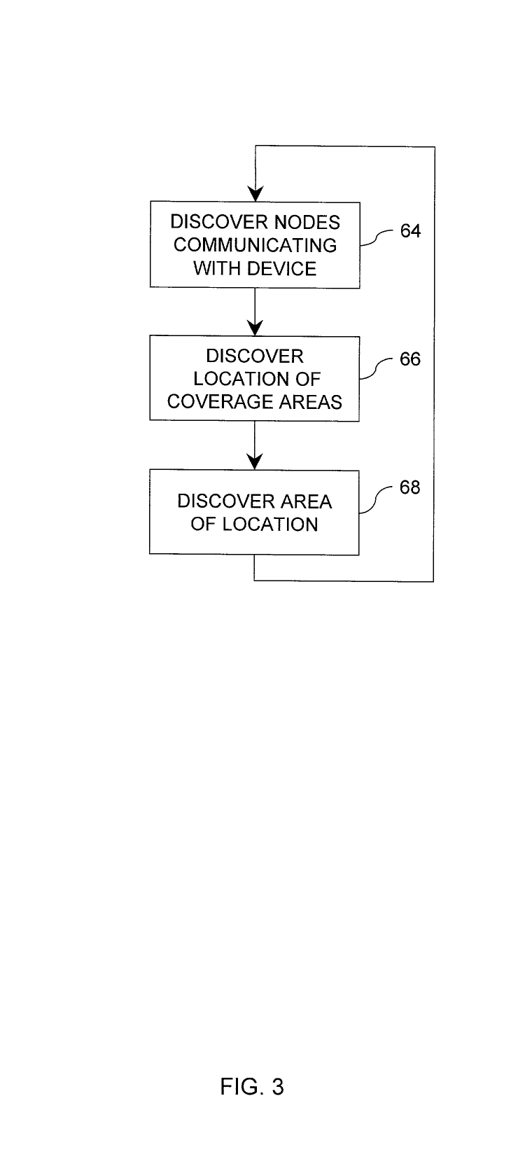

FIG. 3 is a flow chart representing steps of one embodiment of the present invention. Although the steps represented in FIG. 3 are presented in a specific order, the present invention encompasses variations in the order of steps. Furthermore, additional steps may be executed between the steps illustrated in FIG. 3 without departing from the scope of the present invention.

Nodes 2, 4, 6 wirelessly communicating with object device 8 are discovered 64. In one embodiment, nodes 2, 4, 6 are discovered 64 by querying nodes 2, 4, 6 to discover whether object device 8 is wirelessly communicating with node 2, 4, 6.

In an alternative embodiment, nodes 2, 4, 6 are discovered 64 by querying nodes 2, 4, 6 to discover devices wirelessly communicating with each node 2, 4, 6, generating an index of devices wirelessly communicating with each node and node 2, 4, 6 to which each device is wirelessly communicating, selecting object device 8 from the index, and reading the index to discover node 2, 4, 6 wirelessly communicating with object device 8.

For each node wirelessly communicating with object device 8, a location of a coverage area 12, 14, 16 for the node 2, 4, 6 is discovered. In one embodiment, the location of the coverage area 12, 14, 16, for each node 2, 4, 6 wirelessly communicating with object device 8 is discovered by reading the location of the coverage area 12, 14, 16 for each node 2, 4, 6.

In an alternate embodiment, the location of the coverage area 12, 14, 16, for each node 2, 4, 6 is discovered by reading a node location for each node 2, 4, 6 wirelessly communicating with object device 8 and calculating the location of the coverage area 12, 14, 16 from the node location.

From the location of the coverage area 12, 14, 16 for each node 2, 4, 6, wirelessly communicating with object device 8, an area of location for object device 8 is discovered. In one embodiment, the area of location for object device 8 is discovered by discovering a region common to coverage areas 12, 14, 16 for each node 2, 4, 6 communicating wirelessly with object device 8. In another embodiment, the area of location for object device 8 is discovered by discovering a region excluding coverage areas 12, 14, 16 for each node 2, 4, 6 not communicating wirelessly with object device 8. In still another embodiment the area of location for object 8 is discovered by discovering a region common to coverage areas 12, 14, 16 for each node 2, 4, 6 communicating wirelessly with object device 8 and excluding coverage areas 12, 14, 16 for each node 2, 4, 6 not communicating wirelessly with object device 8.

The process is then repeated, if desirable, to keep track of object device 8 as it moves.

In an example illustrated in FIG. 1, node searcher 42 finds that node 2 and node 4 are communicating wirelessly with object device 8. Next, coverage area inspector 44 discovers the locations for coverage area 12 and coverage area 14. Finally, area of location finder compares the overlapping regions of coverage area 12 and coverage area 14 to find an area of location including zone 20 and zone 24. The area of location for object device 8 is then further refined by excluding zone 24 as it is within coverage area 16. The result is that object device 8 is known to be within zone 20.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A method for locating an object device wirelessly communicating with at least one node, the method comprising:
(a) discovering the nodes wirelessly communicating with the object device;
(b) for each node wirelessly communicating with the object device, discovering a location of a coverage area for the node; and,
(c) discovering an area of location for the object device from the location of the coverage area for each node wirelessly communicating with the object device.

2. The method of claim 1 wherein discovering the nodes includes:
(a) querying nodes to discover devices wirelessly communicating with each node;
(b) generating an index of devices wirelessly communicating with each node and the nodes to which each device is wirelessly communicating;
(c) selecting the object device from the index; and,
(d) reading the index to discover the nodes wirelessly communicating with the object device.

3. The method of claim 1 wherein discovering the nodes includes querying nodes to discover whether the object device is wirelessly communicating with the nodes.

4. The method of claim 1 wherein discovering the location of the coverage area for each node wirelessly communicating with the object device includes reading the location of the coverage area for each node wirelessly communicating with the object device.

5. The method of claim 1 wherein discovering the location of the coverage area for each node wirelessly communicating with the object device includes:
(a) reading a node location for each node wirelessly communicating with the object device; and,
(b) calculating the location of the coverage area from the node location.

6. The method of claim 1 wherein discovering the area of location for the object device includes discovering a region common to the coverage areas for each node communicating wirelessly with the object device.

7. The method of claim 1 wherein discovering the area of location for the object device includes discovering a region excluding the coverage areas for each node not communicating wirelessly with the object device.

8. A system for locating an object device wirelessly communicating with at least one node, the system comprising:
(a) a node searcher configured to discover the nodes wirelessly communicating with the object device;
(b) a coverage area inspector configured to discover a location of a coverage area for the node for each node wirelessly communicating with the object device; and,
(c) an area of location finder configured to discover an area of location for the object device from the location of the coverage area for each node wirelessly communicating with the object device.

9. The system of claim 8 wherein the node searcher includes:
(a) an inquirer configured to query nodes to discover devices wirelessly communicating with each node;
(b) an indexer configured to generate an index of devices wirelessly communicating with each node and the nodes to which each device is wirelessly communicating;
(c) a selector configured to select the object device from the index; and,
(d) an index reader configured to read the index to discover the nodes wirelessly communicating with the object device.

10. The system of claim 8 wherein the node searcher includes an inquirer configured to query nodes to discover whether the object device is wirelessly communicating with the nodes.

11. The system of claim 8 the coverage area inspector includes a node reader configured to read the location of the coverage area for each node wirelessly communicating with the object device.

12. The system of claim 8 wherein the coverage area inspector includes:
(a) a node reader configured to read a node location for each node wirelessly communicating with the object device; and,
(b) a calculator configured to calculate the location of the coverage area from the node location.

13. The system of claim 8 wherein the area of location finder includes a mapper configured to discover a region common to the coverage areas for each node communicating wirelessly with the object device.

14. The system of claim 8 wherein the area of location finder includes a mapper configured to discover a region excluding the coverage areas for each node not communicating wirelessly with the object device.

15. A program storage device readable by a computer, tangibly embodying a program, applet or instructions executable by the computer to perform method steps for locating an object device wirelessly communicating with at least one node, the method steps comprising:
(a) discovering the nodes wirelessly communicating with the object device;
(b) for each node wirelessly communicating with the object device, discovering a location of a coverage area for the node; and,
(c) discovering an area of location for the object device from the location of the coverage area for each node wirelessly communicating with the object device.

16. The program storage device of claim 15 wherein the method step of discovering the nodes includes:
(a) querying nodes to discover devices wirelessly communicating with each node;
(b) generating an index of devices wirelessly communicating with each node and the nodes to which each device is wirelessly communicating;
(c) selecting the object device from the index; and,
(d) reading the index to discover the nodes wirelessly communicating with the object device.

17. The program storage device of claim 15 wherein the method step of discovering the nodes includes querying nodes to discover whether the object device is wirelessly communicating with the nodes.

18. The program storage device of claim 15 wherein the method step of discovering the location of the coverage area for each node includes reading the location of the coverage area for each node.

19. The program storage device of claim 15 wherein the method step of discovering the area of location for the object device includes discovering a region common to the coverage areas for each node communicating wirelessly with the object device.

20. The program storage device of claim 15 wherein the method step of discovering the area of location for the object device includes discovering a region excluding the coverage areas for each node not communicating wirelessly with the object device.
